(19) United States
(12) Patent Application Publication
(10) Pub. No.: US 2022/0382591 A1
(43) Pub. Date: Dec. 1, 2022

(54) MANAGING RESOURCE DISTRIBUTION IN GLOBAL AND LOCAL POOLS BASED ON A FLUSH THRESHOLD

(71) Applicant: VMware, Inc., Palo Alto, CA (US)

(72) Inventors: Nitin Rastogi, San Bruno, CA (US); Wenguang Wang, Santa Clara, CA (US); Richard P. Spillane, Palo Alto, CA (US)

(21) Appl. No.: 17/332,133

(22) Filed: May 27, 2021

(51) Int. Cl. G06F 9/50; G06N 20/00

(52) U.S. Cl. CPC G06F 9/5027; G06N 20/00

(57) ABSTRACT

The disclosure herein describes management of distribution of resources between a global pool and an associated plurality of local pools using a flush threshold. A request for resources is received at the global pool from a local pool, the request indicating a requested quantity of resources. Based on the received request, it is determined that available resources in the global pool are below a flush threshold of the global pool. Based on this determination, flush instructions are sent to the local pools, wherein the flush instructions instruct each local pool to release unused resources (e.g., available to be released) to the global pool. Based on the available resources of the global pool then exceeding the requested quantity of resources and/or the flush threshold, resources of the global pool are allocated to the requesting local pool, whereby the local pool is enabled to use the allocated resources.

### BACKGROUND

Distributed computing systems provide highly concurrent resource management systems that require distribution of resources throughout the system to manage basic input/output (I/O) workflows. In situations where a global pool of resources has insufficient resources to satisfy resource requests from local subsystems, it is a significant challenge to effectively and efficiently control the distribution of resources to reduce wait times of the local subsystems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure enable management of distribution of resources between a global pool and an associated plurality of local pools at least by receiving, by a processor of a resource manager of a global pool, a request from a requesting local pool of a plurality of local pools, wherein the request indicates a requested quantity of resources from the global pool; based on receiving the request, determining, by the processor, that a flush threshold of the global pool exceeds an available quantity of resources in the global pool; based on the flush threshold exceeding the available quantity of resources, sending, by the processor, flush instructions to the plurality of local pools, wherein the flush instructions instruct each local pool receiving the flush instructions to release unused resources to the global pool; updating, by the processor, the available quantity of resources of the global pool based on resources released by local pools in response to the flush instructions; and based on the updated available quantity of resources exceeding the requested quantity of resources, allocating, by the processor, a quantity of available resources of the global pool to the requesting local pool, wherein the allocated quantity of available resources matches the requested quantity of resources, whereby the local pool is enabled to use the allocated quantity of available resources.

### BRIEF DESCRIPTION OF THE DRAWINGS

The present description will be better understood from the following detailed description read in light of the accompanying drawings, wherein:

FIG. 1A is a block diagram illustrating an example computing system;

FIG. 1B is a block diagram illustrating a resource manager;

FIG. 2 is a block diagram illustrating system with a resource manager controlling memory distribution between a global pool and local pools;

FIG. 3 is a diagram illustrating management of resources in a distributed file system including a global pool and local pools;

FIG. 4 is a flowchart illustrating a process for managing distribution of resources between a global pool and an associated plurality of local pools; and

FIG. 5 illustrates a computing apparatus.

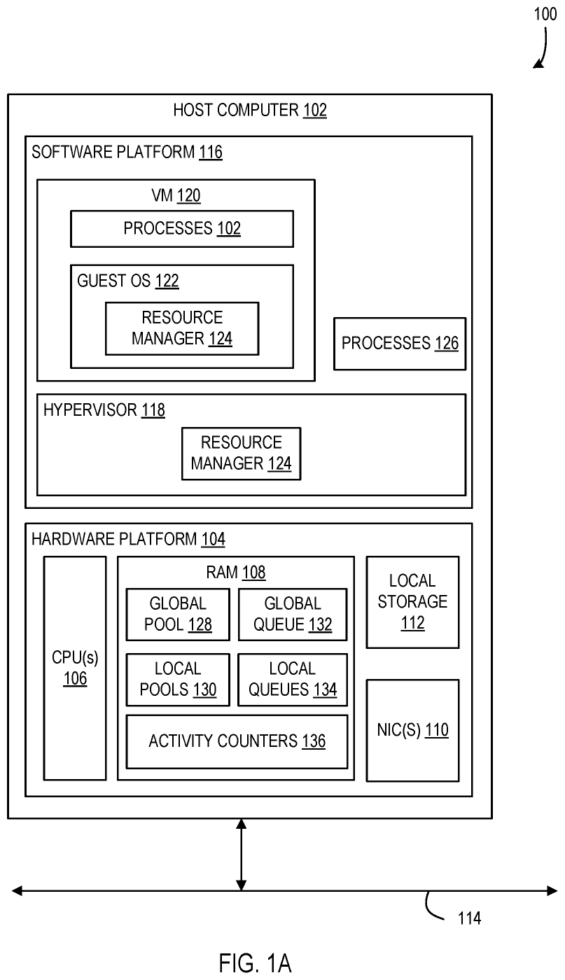

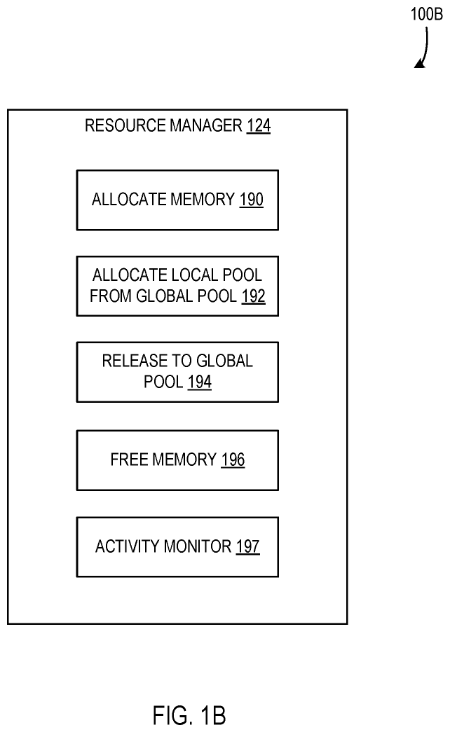

Corresponding reference characters indicate corresponding parts throughout the drawings. In FIGS. 1 to 5, the systems are illustrated as schematic drawings. The drawings may not be to scale.

### DETAILED DESCRIPTION

The disclosure herein describes management of distribution of resources between a global pool and an associated plurality of local pools using a flush threshold. The described systems and methods include a resource manager configured to operate in an unconventional manner by triggering the release of allocated resources in local pools based on available resources in the global pool falling below a defined level, known as the flush threshold. Causing local pools to flush resources not currently in use enables the system to reduce the wait time of resource requests from local pools to the global pool and/or otherwise improve the efficiency of the resource distribution between the global pool and the local pools. In this manner, the operation of the underlying device is improved. In some examples of the described systems and methods, a request for resources is received at the global pool from a local pool, the request indicating a requested quantity of resources. Based on receiving the request, it is determined that allocating the requested quantity of resources would result in the available resources in the global pool falling below the flush threshold. Based on this determination, flush instructions are sent to the local pools, wherein the flush instructions instruct each local pool to release unused resources to the global pool. The available resources of the global pool are updated (e.g., increased) based on resources released by the local pools. Based on the updated available resources matching or exceeding the requested quantity of resources, resources of the global pool are allocated to the requesting local pool, whereby the local pool is enabled to use the allocated resources.

The disclosure improves latency in the associated distributed computing system. Because the global pool of the system is responsible for serving requests to all the local pools, in scenarios when the global pool runs out of resources, it can cause multiple local pools to wait for resources, resulting in significant latency throughout the system. This disclosure describes a proactive approach that reduces such wait times and associated latency. Such latency can also be caused in similar scenarios where the global pool does have some resources, but the quantity is insufficient to fulfill incoming requests from local pools. The described systems and methods also reduce latency in these situations by causing resources to be released from local pools more frequently and in response to reduced available resources at the global pool (e.g., as indicated by the flush threshold).

Further, the disclosure improves the efficiency of resource utilization and lowers the frequency of resource contention in the system. When the global pool is waiting on resources to be released in order to fulfill other local pool resource requests, any resources allocated to local pools that could be released are being used inefficiently. By triggering flush instructions to the local pools based on the described flush threshold, the global pool is less like to be in a state of waiting for resources to be released and, when it is in that state, the time spent in that state is likely to be shorter. This helps improve the functioning of the underlying device(s).

Additionally, the disclosure enables the configuration of the flush threshold to be flexible and dynamic. A user is enabled to define a flush threshold of a system at a start time and to adjust the flush threshold during operation. Such flexibility enables a user to customize the operations of a system based on observed performance of the system (e.g., based on workload attributes specific to the system). In other examples, the flush threshold is adjusted by a process (e.g., machine learning process) based on observed performance of the system. Alternatively, the disclosure enables the configuration of the flush threshold to be fixed to a defined value.

FIG. 1A is a block diagram of a computing system 100. System 100 includes a host computer 102 (also referred to as “host 102”) that may be constructed on a server-grade hardware platform such as an x86 architecture platform.

As shown, a hardware platform 104 of host 102 includes conventional components of a computing device, such as central processing units (CPUs) 106, system memory (e.g., random access memory (RAM) 108), one or more network interface controllers (NICs) 110, and optionally local storage 112. CPUs 106 are configured to execute instructions, for example, executable instructions that perform one or more operations described herein, which may be stored in RAM 108. NICs 110 enable host 102 to communicate with other devices through a physical network 114. Physical network 114 enables communication between hosts 102 and between other components and hosts 102 (other components discussed further herein). Local storage 112 may comprise magnetic disks, solid-state disks, flash memory, and the like as well as combinations thereof. In some examples, local storage 112 in each host 102 can be aggregated and provisioned as part of a virtual storage area network (SAN).

A software platform 116 of host 102 provides a virtualization layer, referred to herein as a hypervisor 118, which directly executes on hardware platform 104. In an example, there is no intervening software, such as a host operating system (OS), between hypervisor 118 and hardware platform 104. Thus, hypervisor 118 is a Type-1 hypervisor (also known as a “bare-metal” hypervisor). As a result, the virtualization layer in a host cluster (collectively hypervisors 118) is a bare-metal virtualization layer executing directly on host hardware platforms. Hypervisor 118 abstracts processor, memory, storage, and network resources of hardware platform 104 to provide a virtual machine execution space within which multiple virtual machines (VM) may be concurrently instantiated and executed. One example of hypervisor 118 that may be configured and used in examples described herein is a VMWARE ESXi™ hypervisor provided as part of the VMWARE VSPHERE® solution made commercially available by VMWARE, Inc. of Palo Alto, Calif.

Each of VMs 120 includes a guest operating system (OS) 122, which can be any known operating system (e.g., Linux®, Windows®, etc.). Processes 102 execute in VMs 120 managed by guest OS 122. Guest OS 122 can also execute a resource manager 124, such as a resource manager or a manager of other types of resources (cache space, log file space, disk space, connections, file descriptors, etc.), that manages allocating and freeing memory for processes 126. In an example, processes 126 execute directly on hypervisor 118 (e.g., as managed by a kernel of hypervisor 118). In such case, hypervisor 118 can include an instance of a resource manager 124 for managing allocating and freeing memory for processes 126. Although a virtualized computing system is shown, in other examples, a computing system includes a host OS executing directly on the hardware platform 104 without an intervening hypervisor (e.g., Linux executing directly on hardware platform 104). In such case, the host OS can include an instance of resource manager 124 to manage memory on behalf of processes managed by the host OS. In examples, an instance of resource manager 124 executes on each CPU 106 (e.g., a thread or process of resource manager 124 executes on each CPU 106). For purposes of clarity, operations are described herein as being executed by resource manager 124 as an aggregate of its processes/threads.

As described further herein, resource manager 124 manages a global memory pool (“global pool 128”) and local memory pools (“local pools 130”). Global pool 128 is shared by all CPUs 106. Each CPU 106 can have its own local pool 130 (e.g., each local pool 130 is specific to a particular CPU 106). Note that some CPUs 106 may have an empty local pool 130 (e.g., a local pool with no allocated resources) at any given time depending on demand for memory by processes. Resource manager 124 also maintains a global wait queue (“global queue 132”) and local wait queues (“local queues 134”). In examples, resource manager 124 also maintains activity counters 136 for CPUs 106, respectively. Local queues 134 hold allocation requests from local pools 130 that cannot be fulfilled due to insufficient memory or lack of allocated local queue. Global queue 132 holds local pool allocation requests that cannot be fulfilled due to insufficient memory in global pool 128. Activity counters 136 monitor allocation activity on each CPU 106 and can be used by resource manager 124 to release local pools 130 to global pool 128 in case of inactivity.

FIG. 1B is a block diagram 100B depicting resource manager 124. Resource manager 124 includes a routine for allocating memory (“Allocate Memory 190”), a routine for allocating a local pool from the global pool (“Allocate Local Pool from Global Pool 192”), a routine to release a local pool to the global pool (“Release to Global Pool 194”), and a routine to free memory from to a local pool (“Free Memory 196”). A process can call Allocate Memory 190 to obtain a memory allocation from a local pool. A process can call Free Memory 196 to free memory obtained using allocate memory 190. Allocate memory 190 and Free Memory 196 can call Allocate Local Pool from Global Pool 192 and Release to Global Pool 194, as described further below. In some examples, resource manager 124 includes activity monitor 197 configured to monitor activity counters 136 (if present).

In some examples, at system start, all available memory is claimed by global pool 128. Alternatively, at system start, a defined quantity or percentage of available memory in the system is claimed by the global pool 128 (e.g., a pre-defined percentage between a minimum percentage and 100% may be used). “Available memory” depends on where resource manager 124 is executing. For example, for resource manager 124 executing in hypervisor 118, “available memory” includes all physical memory in RAM 108, since hypervisor 118 manages all physical memory in RAM 108. For resource manager 124 executing in a VM 120, “available memory” includes all memory allocated to VM 120 by hypervisor 118, which can be less than all memory in RAM 108. Thus, depending on configuration, RAM 108 can have more than one global pool 128 (e.g., one global pool for each executing VM 120).

When a process requires memory, the process calls Allocate Memory 190 to request a memory allocation from a local pool for the processor on which the process executes. If local pool 130 has sufficient memory to serve the request, resource manager 124 will fulfill the request from local pool 130. This memory allocation from local pool 130 is lockless (e.g., resource manager 124 does not lock local pool 130 when allocating memory from local pool 130). If local pool 130 does not have sufficient memory, resource manager 124 requests a chunk of memory from global pool 128 to serve as a new local pool 130 for the processor using Allocate Local Pool from Global Pool 192. The chunk of memory is an amount of memory large enough to fulfill a number of memory allocation requests by processes executing on that processor (e.g., defined by some threshold amount of memory for each local pool 130). The allocation of memory for a local pool 130 from global pool 128 is performed by locking global pool 128, since global pool 128 is shared by multiple processors (e.g., CPUs 106).

Processes release memory back to the local pools 130 by calling Free Memory 196. This is also a lockless operation (e.g., resource manager 124 does not lock local pool 130 when releasing memory back to local pool 130). When a threshold amount of free memory exists in local pool 130, resource manager 124 can release local pool 130 back to global pool 128 using Release to Global Pool 194. If there is no memory available in local pool 130 when an allocation request is made, resource manager 124 queues the request in a local wait queue (e.g., local queues 134) for the processor. The memory allocation requests in the local wait queue are blocked (e.g., the system waits to fulfill the request) until sufficient memory in local pool 130 becomes available. If a first memory allocation request is received such that the associated local pool 130 has no memory yet allocated, resource manager 124 executes Allocate Local Pool from Global Pool 192 to allocate memory to the empty local pool 130 from global pool 128. The process of allocating memory to a new or empty local pool 130 may block subsequent allocation requests (e.g., when global pool 128 has insufficient memory for a new local pool 130). Blocked requests are added to the local wait queue until the new local pool is allocated. This reduces contention on global pool 128.

All released memory is accumulated locally and only returned to global pool 128 when the accumulated size is greater than a threshold, in some examples. This may cause some of the memory to be unavailable despite an idle CPU. To remediate this issue, resource manager 124 can use a monotonously increasing counter (e.g., activity counters 136) for each CPU 106. The activity counter is incremented on each allocation and deallocation. For an idle CPU, the activity counter changes little over time. Resource manager 124 can detect this condition and then reclaim all memory in a local pool for a given processor.

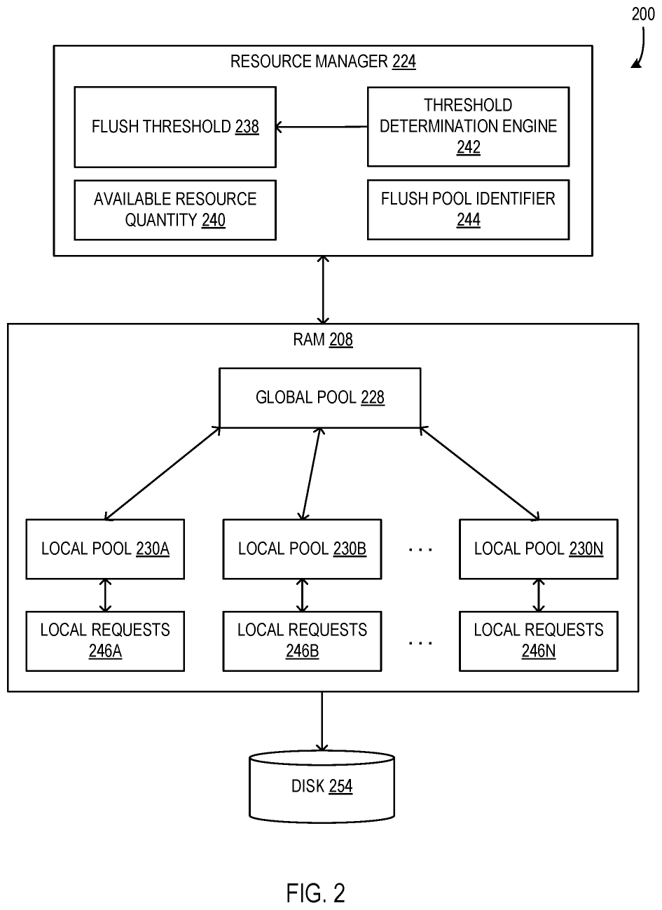

FIG. 2 is a block diagram illustrating system 200 with a resource manager 224 controlling memory distribution between a global pool 228 and local pools 230A-230N. In some examples, the resource manager 224 and RAM 208 are in a system such as system 100 as described above with respect to FIGS. 1A and 1B.

In some examples, the resource manager 224 includes hardware, firmware, and/or software configured to manage the distribution of memory resources of the RAM 208 between the global pool 228 and the local pools 230A, 230B, and/or 230N. The resource manager 224 is configured to enable the memory resources of the RAM 208 to be allocated from the global pool 228 to the local pools 230A-230N based on requests made by the local pools 230A-230N. The memory resources allocated to the local pools may be used to perform operations in response to local requests 246A-246N respectively and/or to otherwise handle the local requests 246A-246N. For instance, a local request 246A may require a quantity of memory resources and, based on the local request 246A being initiated, the associated local pool 230A may send a request for the memory resources from the global pool 228. Alternatively, if the local pool 230A already includes sufficient memory resources to handle the local request 246A, those resources may be used to do so.

In response to the request for memory resources from the local pool 230A, the resource manager 224 may be configured to allocate memory resources from the global pool 228 to the local pool 230A. If the global pool 228 has insufficient available resources (e.g., the requested quantity of memory resources exceeds the available resource quantity 240) for allocation, the request from the local pool 230A may be set into a waiting state, such that the request from the local pool 230A is not satisfied with memory resource allocation until sufficient memory resources become available at the global pool 228. Multiple memory resource requests may be set into waiting states in a queue, and the resource manager 224 is configured to respond to the queued memory resource requests (e.g., in some order) as memory resources become available. In some examples, the resource manager 224 prioritizes the queued memory resource requests based on order of receipt (e.g., timestamped), a priority of the local pools (e.g., based on criticality of operations or service level agreements), or any other priority-based ranking.

Further, in some examples, the resource manager 224 is configured to include a flush threshold 238. The flush threshold 238 is a defined value that is used by the resource manager 224 to determine when to send flush instructions to one or more of the local pools 230A-230N to free up memory resources for the global pool 228 (e.g., a “watermark” used to trigger flush instructions). The resource manager 224 is configured to compare the flush threshold 238 with the current available resource quantity 240 (e.g., the quantity of available memory resources in the global pool 228) and, if the flush threshold 238 exceeds the available resource quantity 240, the resource manager 224 is configured to send flush instructions to at least a portion of the local pools 230A-230N. In some examples, the resource manager 224 performs this threshold comparison or threshold check periodically or otherwise according to a defined schedule. Alternatively, or additionally, the resource manager 224 performs the threshold comparison based on defined events (e.g., the threshold comparison is performed based on the global pool 228 having insufficient available memory resources to respond to a memory resource request from a local pool 230A-230N and/or the threshold comparison is performed based on an allocation of resources to a local pool, which reduces the available resources of the global pool). An example process of evaluating the flush threshold 238 is provided in pseudocode below:

```
Procedure FlushThresholdCheck
  RequestedResources is a value indicating a quantity
of resources requested by the local pool from the global
pool;
  TotalResources is a value indicating a total
quantity of resources given to the global pool at system
start;
  FlushThreshold is a value indicating a percentage of
TotalResources at which threshold-based flush
instructions are triggered;
  AvailableResources is a value indicating a quantity
of resources currently available in the global pool;
  If (AvailableResources > RequestedResources) Then
    AllocateResourcesToLocalPool;
    AvailableResources = AvailableResources −
RequestedResources;
  Else WaitOnRequest;
  If (AvailableResources/TotalResources <=
FlushThreshold) Then TriggerFlushInstructions;
```

Additionally, the resource manager 224 is configured to monitor and/or maintain the available resource quantity 240, which is a data value indicative of the quantity of available memory resources in the global pool 228 of the RAM 208. The resource manager 224 may be configured to update the available resource quantity 240 based on memory resources being allocated from the global pool 228 to a local pool 230A-230N (e.g., the available resource quantity 240 is reduced by the amount of memory resources being allocated) and to update the available resource quantity 240 based on memory resources being released back to the global pool 228 by local pools 230A-230N (e.g., the available resource quantity 240 is increased by the amount of memory resources being released).

In some examples, the flush threshold 230 is defined as a memory quantity value (e.g., a value measured in bytes of memory, such as 30 MB, 50 GB, or the like). Alternatively, or additionally, the flush threshold 230 may be defined as a percentage value of a maximum available resource quantity 240 value. For instance, if the global pool 228 has a maximum available resource quantity value of 100 GB and the flush threshold 230 is defined as a 50% threshold, the sending of flush instructions as described herein may be triggered when the available resource quantity 240 is less than 50 GB (the 50% threshold of 100 GB is 50 GB). In a similar example, the sending of flush instructions may be triggered when the available resource quantity 240 is less than or equal to the 50% threshold, or otherwise approximately at the 50% threshold.

Further, in some examples, the resource manager 224 is configured to include a threshold determination engine 242 that is configured to determine the flush threshold 230 to be used by the resource manager 224. The threshold determination engine 242 may be configured to determine a flush threshold 230 based on threshold settings or rules. For instance, the threshold determination engine 242 may evaluate metadata of the current operation of the system and adjust or otherwise determine the flush threshold 230 based thereon. For example, the engine 242 determines a higher or lower flush threshold 230 based on the current workload of the system (e.g., a lower threshold 230 may result in more efficiencies when there is a high percentage of write input/output (I/O)).

Such determinations may be performed during the operation of the system, such that the flush threshold 230 is adjusted by the threshold determination engine 242 over time. For instance, the threshold determination engine 242 may be configured to adjust the flush threshold 230 to increase or decrease it based on the quantity of resource requests from local pools that are queued and waiting (e.g., the flush threshold 230 may be reduced as the quantity of waiting resource requests and/or the total resources being requested increases and the flush threshold 230 may be increased as the quantity of waiting resource requests and/or the total resources being requested decreases).

Additionally, or alternatively, feedback associated with the performance of the RAM 208 and/or other aspects of the RAM 208 may be collected and used by the threshold determination engine 242 to optimize the determination of the flush threshold 230 using machine learning techniques. For instance, the threshold determination engine 242 may be trained or otherwise tuned to determine a flush threshold 230 in such a way as to reduce wait times associated with queued resource requests.

During and after a machine learning-based training process, the threshold determination engine 242 is configured to receive input associated with the operations and performance of the resource manager 224 and the associated resources of the RAM 208, adjust the flush threshold 230 based on the input, and determine resulting effects of those adjustments on the performance of the resource manager 224. The training of the threshold determination engine 242 and associated adjustments made to the flush threshold 230 may be based on analysis of performance data of the resource manager 224, identification of patterns of resource requests from local pools that are associated with particular behaviors or types of operations, etc. Further, in some examples, the training of the threshold determination engine 242 and adjustment of the flush threshold 230 is performed using deep learning classification algorithms and/or other machine learning techniques.

In some examples, the threshold determination engine 242 includes a machine learning module that comprises a trained regressor such as a random decision forest, a directed acyclic graph, a support vector machine, a convolutional neural network or other neural network, or another trained regressor. Such a trained regressor may be trained using performance data of the resource manager 224 as feedback data. It should further be understood that the machine learning module, in some examples, operates according to machine learning principles and/or techniques known in the art without departing from the systems and/or methods described herein.

In an example, the machine learning module of the threshold determination engine 242 makes use of training data pairs when applying machine learning techniques and/or algorithms. Millions of training data pairs (or more) may be stored in a machine learning data structure. In some examples, a training data pair includes a timestamp-based feedback data value (e.g., a data value indicating a performance attribute of the resource manager 224, such as an average wait time of resource requests for resources from the global pool 228) paired with an interval adjustment value (e.g., a value applied to the flush threshold 230 to adjust it). The pairing of the two values demonstrates a relationship between the feedback data value and the adjustment values that may be used by the machine learning module to determine future interval adjustments according to machine learning techniques and/or algorithms. In some examples, the training data includes a clock data point (e.g., hour of the day, day of the week, day of the month, month of the year) paired with the rest of the performance and timestamp-based feedback. The clock data point may help the machine learning process detect patterns related to the time and make better reactions and predictions about deriving the best threshold working for that moment.

Further, in some examples, the resource manager 224 includes a flush pool identifier 244 that is configured to identify a subset of the local pools 230A-230N to be targeted with flush instructions to free up memory resources as described herein. In some cases, the flush instructions are sent to all local pools 230A-230N, but in other cases, the flush instructions may be targeted at a smaller group of local pools (e.g., a subset) to enable more efficient or otherwise optimized flush instruction processing. For instance, when flush instructions are indicated, whether based on a defined flush schedule or based on a flush threshold comparison, the flush pool identifier 244 may identify a subset of local pools that currently have at least a defined amount of allocated memory resources (e.g., all local pools with greater than 10 megabytes (MB) of memory resources allocated are identified as targets for flush instructions). In such cases, the local pools with the largest amounts of allocated memory resources are the most likely to have memory resource that can be released. In other examples, other methods or types of flush pool identification may be used by the flush pool identifier 244 without departing from the description. For example, the resource manager 224 may query one or more of the local pools to identify the amount of memory available for release by those local pools, and then selectively target the local pools based on this information (e.g., if one pool has enough memory to bring the resource level of the global pool above the flush threshold, only that pool is instructed to release the memory).

The local pools 230A-230N may be configured to receive and process flush instructions from the resource manager 224. In some examples, the local pools 230A-230N are configured to identify some or all allocated memory resources that are available for release and release those identified memory resources upon receiving flush instructions from the resource manager 224. For instance, local pool 230B may have a set of allocated memory resources and that set of memory resources may include a subset of memory resources that are allocated but that are not being used to respond to local requests 246B currently. In response to receiving a flush instruction from the resource manager 224, the local pool 230B may identify that subset of memory resources and release that identified subset of memory resources back to the global pool 228. The received flush instructions may be based on a periodic or scheduled flush process or on a threshold-based flush process associated with the flush threshold 230 as described herein. In some examples, execution of the flush instructions results in certain operations being performed, such as committing data changes to a disk 254.

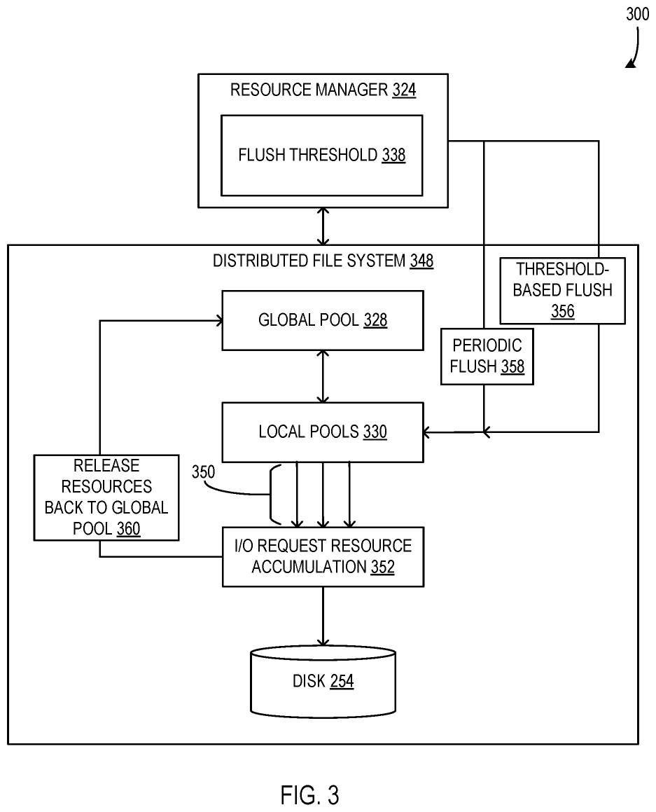

FIG. 3 is a diagram 300 illustrating management of resources in a distributed file system 348 including a global pool 328 and local pools 330. In some examples, the distributed file system 348 and resource manager 324 of diagram 300 may be part of or otherwise associated with a system such as system 100 of FIG. 1.

In some examples, the distributed file system 348 (e.g., a virtual distributed file system (VDFS)) is configured to use resources (e.g., resources assigned to the global pool 328 and/or resources allocated from the global pool 328 to the local pools 330) to manage the storage of data therein. For instance, the resources used in the global pool 328 and local pools 330 include short-term and/or high-speed data storage resources (e.g., memory resources or the like) used to store changes to data in the distributed file system 348 prior to committing those changes to the disk 254, which includes longer-term, slower, or otherwise less responsive data storage resources (e.g., physical hard drives). As a result of this resource management method, concurrent I/O requests 350 processed using resources allocated to the local pools 330 may result in I/O request resource accumulation 352 (e.g., accumulated data storage resources that store changes that have yet to be committed to the disk 254).

The global pool 328 is initiated during the startup of the system and it is configured to distribute resources to local pools 330 as described herein. In the illustrated distributed file system 348, a single global pool 328 is used, regardless of the quantity of sub-volumes and associated local pools 330 being served by the global pool 328. Alternatively, in other examples, multiple global pools 328 may be used without departing from the description. The flush threshold 338 of the resource manager 324 may be associated with the global pool 328 specifically. Additionally, or alternatively, the flush threshold 338 of the global pool 328 may be stored in or otherwise with the global pool 328 and it may be accessed by the resource manager 324 to perform the operations described herein.

The local pools 330 may define resource pools for each processor core or processor associated with the distributed file system. Every core in the system may claim a portion of the global pool 328 in the form of a local pool 330 which is then used to serve I/O requests (e.g., concurrent I/O requests 350) on the associated core. Resource reclamation for all I/Os of a core occurs in association with the associated local pool 330. Further, the resources being used for metadata updates to the system associated with all processed I/O requests are aggregated together, represented by the I/O request resource accumulation 352 (e.g., the accumulation of resources per an entire VDFS volume) as illustrated.

In some examples, the resource manager 324 is configured to send flush instructions to the local pools 330, including threshold-based flush instructions 356 based on a flush threshold 338 and/or periodic flush instructions 358, as described here. For instance, the resource manager 324 may be configured to send threshold-based flush instructions 356 to the local pools 330 when the available resources in the global pool 328 drop below the flush threshold 338 and to send periodic flush instructions 358 to the local pools 330 once per day at a defined time (e.g., 4:00 AM), once every six hours, or on a different defined schedule. Such a schedule may be adjusted during operation of the system to improve the performance of the system (e.g., reduce wait times for I/O requests) manually based on changes made by a user or automatically based on defined system configurations or rules.

In some examples, the flushing of local pools 330 is asynchronous in nature and global pool 328 can continue to serve other requests with the remaining resources. The flush instructions 356 and 358 are sent per volume (e.g., per VDFS volume) such that each local pool of the volume is sent flush instructions 356 and 358, so these instructions may be processed in parallel (e.g., flush instructions to a first local pool 330 and a second local pool 330 are processed simultaneously).

Additionally, or alternatively, in response to flush instructions 356 and/or 358, the local pools 330 may be configured to flush the resources of the I/O request resource accumulation 352 by committing the associated changes to the disk 254. After the associated changes are committed to the disk 254, the data storage resources of the I/O request resource accumulation 352 can be released safely back to the global pool at 360.

In some examples, the lifecycle of an I/O request in the illustrated distributed file system 348 (e.g., a concurrent I/O request 350) begins with resource allocation from the associated local pool 330. This allocation may be done using either a predefined size or quantity of resources or a dynamically calculated size or quantity of resources (e.g., a quantity of resources necessary to process or handle the I/O request). In some examples, the allocation of the resources is based on the maximum possible resource quantity required to account for in-memory resource consumption during the lifecycle of the I/O request. If sufficient resources are not available in the local pool 330, the local pool 330 requests a predefined quantity of resources from the global pool 328. The global pool 328 processes the request if enough resources are available, such that the requested resources are allocated from the global pool 328 to the requesting local pool 330. If there are not enough resources at the global pool 328, the request is set into a waiting state until sufficient resources are released from those other local pools 330. Threshold-based flush instructions 356 may also be triggered if the currently available resources in the global pool 328 are exceeded by (e.g., less than) the flush threshold 338, as described herein. Additionally, or alternatively, a periodic flush 358 may be performed based on a defined flush schedule, resulting in resources being released back to the global pool 328 at 360, which may result in those released resources being allocated to the I/O request.

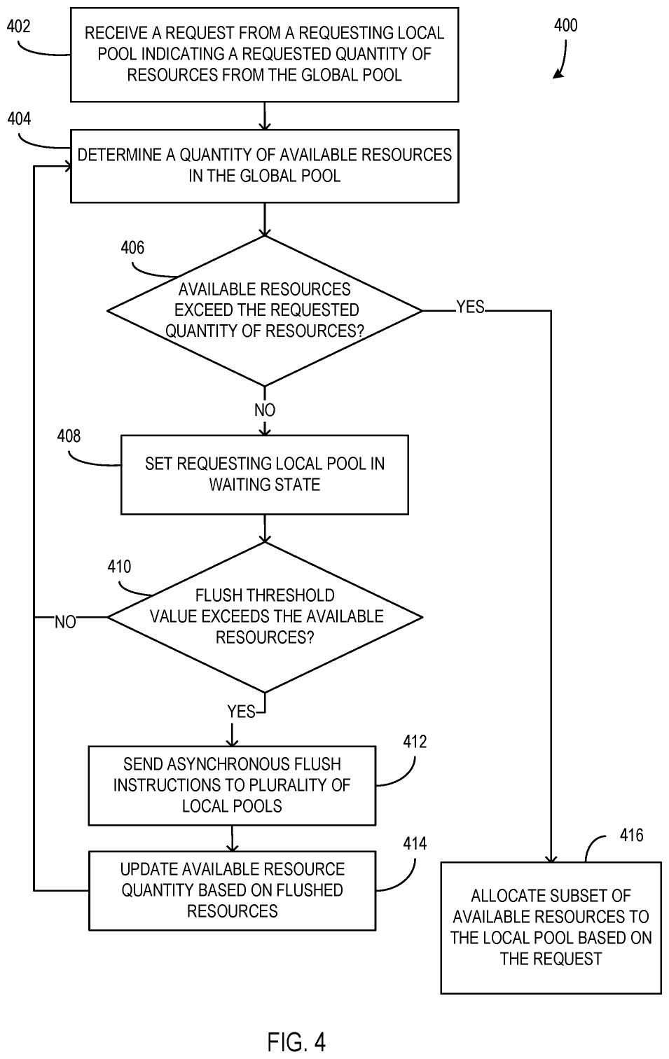

FIG. 4 is a flowchart illustrating a process 400 for managing distribution of resources between a global pool (e.g., global pool 228, 328) and an associated plurality of local pools (e.g., local pools 230A-230N, 330). In some examples, the process 400 is executed or otherwise performed by or in association with a system such as systems 100, 200, and/or 300 of FIGS. 1, 2, and/or 3, respectively. For instance, the process 400 may be performed by a resource manager 224 of system 200 in FIG. 2.

At 402, a request is received from a local pool indicating a requested quantity of resources from the global pool. In some examples, the requesting local pool is a pool of resources, such as memory resources, that are used by a processing entity, such as a virtual machine or other virtual computing instance, to handle I/O requests. Alternatively, or additionally, the requested resources may include other types of resources, such as data processing resources, data storage resources, or the like. Further, the request may be received by a resource manager, such as resource manager 224, associated with the global pool, enabling that resource manager to handle the request, including allocating resources to the local pool in response, setting the request into a wait queue or otherwise into a waiting state, and/or sending flush instructions to free up additional resources, as described herein.

At 404, a quantity of available resources in the global pool is determined. In some examples, the quantity of available resources in the global pool is monitored and dynamically updated as those resources are allocated to local pools and/or released by local pools. Additionally, or alternatively, receiving the request at 402 may trigger a process that determines the current quantity of available resources to evaluate how to respond to the request (e.g., the resource manager 224 determines the quantity of available resources in the global pool based on receiving the request from the local pool).

At 406, if the available resources exceed the requested quantity of resources, the process proceeds to 416. Alternatively, if the available resources do not exceed the requested quantity of resources, the process proceeds to 408.

At 408, the request from the local pool is set in a waiting state. In some examples, the request is added to a wait queue of requests that are waiting to be satisfied as resources are released or otherwise become available. In such examples, the requests may be processed in the order in which they are added to the wait queue (e.g., the first request to be added to the wait queue is the first request to be processed when sufficient resources become available). Alternatively, or additionally, waiting requests may be processed in an order based on the quantity of resources requests (e.g., the request requesting a smaller quantity of resources may be processed as soon as that smaller quantity becomes available, while a request requesting a larger quantity of resources may wait longer for that larger quantity of resources to become available). Such ordered processing may be configured to ensure that larger requests for resources are not waiting indefinitely (e.g., if a request waits for more than a defined wait threshold, it becomes the next request to be processed, regardless of the quantity of resources being requested). In other examples, other methods of handling and processing waiting requests may be used without departing from the description.

At 410, if the flush threshold value exceeds the available resources, the process proceeds to 412. Alternatively, if the flush threshold value does not exceed the available resources, the process returns to 404, where the current quantity of available resources in the global pool is determined again. If that quantity has increased sufficiently to satisfy the waiting request, the process may proceed to 406 and then to 416.

At 412, because the flush threshold value exceeds available resources, asynchronous flush instructions are sent to a plurality of the local pools. The flush instructions are configured to cause the receiving local pools to release resources that are no longer needed or being used. In some examples, the flush instructions cause the receiving local pools to commit data changes from allocated memory resources to disks or other data storage resources, such that the allocated memory resources upon which the data changes were stored can be released back to the global pool. In other examples, other methods of identifying resources that can be released may be used without departing from the description (e.g., a local pool process configured to identify ways that data in allocated memory resources can be rearranged based on a current stage of a data process, resulting in some allocated memory resources being freed up and released to the global pool).

At 414, the available resource quantity of the global pool is updated based on the flushed resources (e.g., the resources that are released by the local pools as a result of the sent flush instructions). As previously mentioned, the current available resource quantity of the global pool may be monitored and updated dynamically as changes occur. After the update is done, the process returns to 404 and, because of the release of resources based on the flush instructions, the available resource quantity of the global pool may now exceed the requested quantity of resources and/or the flush threshold.

In some examples, there may be enough resources in the global pool to satisfy the requested quantity of resources, but the resources in the global pool may still be less than the flush threshold. In such examples, the resources in the global pool will be allocated once the resources in the global pool exceed the flush threshold. Alternatively, the global pool is configured to process incoming requests for resources independently of the flush threshold based on currently available resources.

At 406, if the available resources exceed the requested quantity of resources, the process proceeds to 416, as previously described. At 416, a quantity of available resources of the global pool are allocated to the requesting local pool based on the request. The quantity allocated may match or exceed the requested quantity of resources, such that the request is satisfied. If the request was previously placed in a wait queue or otherwise a waiting state, it is updated to reflect that it has been processed (e.g., it is removed from the wait queue).

As illustrated, the flush threshold check at 410 occurs when the available resources of the global pool do not exceed (e.g., are less than or equal to) the requested quantity of resources. Additionally, or alternatively, the flush threshold check at 410 may be triggered based on the reception of any resource request or based on the reception of a defined type or category of a resource request. In such examples, upon receiving the request at 402, the flush threshold check at 410 may be performed prior to or at substantially the same time as the evaluation of the available resources with respect to the requested quantity of resources at 406 (e.g., in parallel processes). In this manner, the flush threshold may be checked more frequently, keeping the available resources of the global pool above the defined flush threshold more reliably. In other examples, other triggers of flush threshold checks may be used without departing from the description.

In addition to the flush instructions sent as a result of the flush threshold check at 410, sending flush instructions may also be triggered by a periodic flush schedule. Such a schedule may cause flush instructions to be sent to local pools once a day, every six hours, every twelve hours, or the like. Other types of periodic scheduling may also be used without departing from the description.

Further, in some examples, the processing of the flush instructions at the local pools is done asynchronously with the processing of resource requests (e.g., by the resource manager 224). As a result, resource requests may continue to be processed while the flush instructions are being processed at the local pools, such that they occur in parallel or at substantially the same time.

In some examples, sending the asynchronous flush instructions to a plurality of local pools includes identifying a subset of local pools of the plurality of local pools based on allocated resource quantities of the identified subset of local pools exceeding an allocated resource threshold. Then, the flush instructions are sent to those identified local pools. The allocated resource threshold may be defined to be a quantity value or a percentage value of a maximum allocated resource value (e.g., a 3 MB allocated memory resource threshold, a 90% allocated resource threshold, a 100% allocated resource threshold or maximum allocated resource threshold). Sending flush instructions to a subset of local pools that have the largest quantities of allocated resources based on such a threshold may result in a higher likelihood that sufficient resources are released while avoiding causing all local pools to process flush instructions, reducing some of the processing costs associated with sending such widespread flush instructions.

Further, in some examples, wait time data of resource requests to the global pools is collected. Based on the collected wait time data, the flush threshold is adjusted to reduce or otherwise improve future wait times for resource requests. In some examples, the average wait time of requests in a wait queue associated with the global pool is calculated. If that average wait time is high relative to other previously calculated average wait times, the flush threshold of the global pool may be adjusted to be higher, such that sending flush instructions is triggered more often based on the flush threshold. If, after such an adjustment is made, the average wait time of resource requests does not decrease, it may be determined that the adjustment was ineffective (e.g., the cause of the high or increased wait time is not the rate at which flush instructions are sent) and the flush threshold may be reverted to its previous value or otherwise adjusted. Such adjustment and tuning of the flush threshold may be performed using machine learning techniques, as described herein.

Additionally, other factors may be used to adjust, tune, or otherwise improve the performance of the system based on the flush threshold. In some examples, the type of workload of I/O requests being processed by the system may be indicative of the level at which the flush threshold should be set for optimized performance. For instance, if the workload is “write heavy” (e.g., a large portion of the I/O requests are write I/O requests), the system may benefit from a flush threshold that is set lower than if the workload is “read heavy” (e.g., a large portion of the I/O requests are read I/O requests). The flush threshold may be adjusted or tuned based on such differences by monitoring the attributes of the current workload and adjusting the flush threshold accordingly. Other attributes of the workload may be used without departing from the description. These adjustments may also be performed using machine learning techniques, as described herein.

### Exemplary Operating Environment

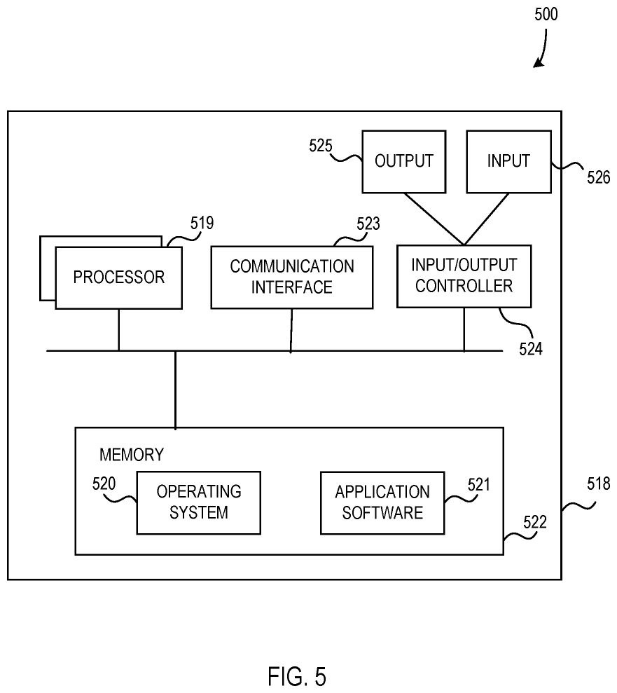

The present disclosure is operable with an example computing apparatus such as shown in a functional block diagram 500 in FIG. 5. In an example, components of a computing apparatus 518 may be implemented as a part of an electronic device according to one or more examples described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hardcoded machine. Platform software comprising an operating system 520 or any other suitable platform software may be provided on the apparatus 518 to enable application software 521 to be executed on the device. According to an example, distributing resources of a global pool to local pools, including sending flush instructions based on a flush threshold, as described herein may be accomplished by software, hardware, and/or firmware.

Computer executable instructions may be provided using any computer-readable media that are accessible by the computing apparatus 518. Computer-readable media may include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 522) is shown within the computing apparatus 518, it will be appreciated by a person skilled in the art, that the storage may be distributed or located remotely and accessed via a network or other communication link (e.g., using a communication interface 523).

The computing apparatus 518 may comprise an input/output controller 524 configured to output information to one or more output devices 525, for example a display or a speaker, which may be separate from or integral to the electronic device. The input/output controller 524 may also be configured to receive and process an input from one or more input devices 526, for example, a keyboard, a microphone, or a touchpad. In one example, the output device 525 may also act as the input device. An example of such a device may be a touch sensitive display. The input/output controller 524 may also output data to devices other than the output device, e.g., a locally connected printing device. In some examples, a user may provide input to the input device(s) 526 and/or receive output from the output device(s) 525.

The functionality described herein can be performed, at least in part, by one or more hardware logic components. According to an example, the computing apparatus 518 is configured by the program code when executed by the processor 519 to execute the examples of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example computer system for managing distribution of resources between a global pool and an associated plurality of local pools comprises: a processor; and a non-transitory computer readable medium having stored thereon program code for transferring data to another computer system, the program code causing the processor to: receive a request from a requesting local pool of a plurality of local pools, wherein the request indicates a requested quantity of resources from a global pool; based on receiving the request, determine that a flush threshold of the global pool exceeds an available quantity of resources in the global pool; based on the flush threshold exceeding the available quantity of resources, send flush instructions to the plurality of local pools, wherein the flush instructions instruct each local pool receiving the flush instructions to release unused resources to the global pool; update the available quantity of resources of the global pool based on resources released by local pools in response to the flush instructions; and based on the updated available quantity of resources exceeding the requested quantity of resources, allocate a quantity of available resources of the global pool to the requesting local pool, wherein the allocated quantity of available resources matches the requested quantity of resources, whereby the local pool is enabled to use the allocated quantity of available resources.

An example method for managing distribution of resources between a global pool and an associated plurality of local pools comprises: receiving, by a processor of a resource manager of a global pool, a request from a requesting local pool of a plurality of local pools, wherein the request indicates a requested quantity of resources from the global pool; based on receiving the request, determining, by the processor, that a flush threshold of the global pool exceeds an available quantity of resources in the global pool; based on the flush threshold exceeding the available quantity of resources, sending, by the processor, flush instructions to the plurality of local pools, wherein the flush instructions instruct each local pool receiving the flush instructions to release unused resources to the global pool; updating, by the processor, the available quantity of resources of the global pool based on resources released by local pools in response to the flush instructions; and based on the updated available quantity of resources exceeding the requested quantity of resources, allocating, by the processor, a quantity of available resources of the global pool to the requesting local pool, wherein the allocated quantity of available resources matches the requested quantity of resources, whereby the local pool is enabled to use the allocated quantity of available resources.

A non-transitory computer storage medium has stored thereon program code executable by a first computer system at a first site, the program code embodying a method that comprises: receiving a request from a requesting local pool of a plurality of local pools, wherein the request indicates a requested quantity of resources from a global pool; based on receiving the request, determining that a flush threshold of the global pool exceeds an available quantity of resources in the global pool; based on the flush threshold exceeding the available quantity of resources, sending flush instructions to the plurality of local pools, wherein the flush instructions instruct each local pool receiving the flush instructions to release unused resources to the global pool; updating the available quantity of resources of the global pool based on resources released by local pools in response to the flush instructions; and based on the updated available quantity of resources exceeding the requested quantity of resources, allocating a quantity of available resources of the global pool to the requesting local pool, wherein the allocated quantity of available resources matches the requested quantity of resources, whereby the local pool is enabled to use the allocated quantity of available resources.

Alternatively, or in addition to the other examples described herein, examples include any combination of the following:
sending, by the processor, flush instructions to the plurality of local pools periodically based on a defined schedule.
wherein the flush instructions instruct each local pool to release unused resources asynchronously; and wherein the resource manager is configured to process resource requests while sent flush instructions are processed at the plurality of local pools.
based on the requested quantity of resources exceeding the available quantity of resources, adding, by the processor, the received request to a wait queue of requests, wherein the resource manager allocates available resources to local pools associated with requests in the wait queue of requests based on an order of requests in the wait queue of requests.
wherein sending flush instructions to the plurality of local pools further includes: identifying, by the processor, a subset of local pools of the plurality of local pools based on allocated resource quantities of the identified subset of local pools exceeding an allocated resource threshold; and sending, by the processor, the flush instructions to the identified subset of local pools.
collecting, by the processor, wait time data of resource requests associated with the global pool and the plurality of local pools; training, by the processor, a threshold determination engine based on the collected wait time data using machine learning; and based on the trained threshold determination engine, adjusting, by the processor, the flush threshold to reduce wait times of resource requests.
wherein, based on receiving flush instructions, the plurality of local pools process the flush instructions, the processing including: identifying allocated resources associated with accumulated system metadata updates; writing the accumulated system metadata updates of the identified allocated resources to a disk; and releasing the identified allocated resources to the global pool.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but with the scope of aspects of the claims constitute exemplary means for receiving, by a processor of a resource manager of a global pool, a request from a requesting local pool of a plurality of local pools, wherein the request indicates a requested quantity of resources from the global pool; based on receiving the request, exemplary means for determining, by the processor, that a flush threshold of the global pool exceeds an available quantity of resources in the global pool; based on the flush threshold exceeding the available quantity of resources, exemplary means for sending, by the processor, flush instructions to the plurality of local pools, wherein the flush instructions instruct each local pool receiving the flush instructions to release unused resources to the global pool; exemplary means for updating, by the processor, the available quantity of resources of the global pool based on resources released by local pools in response to the flush instructions; and based on the updated available quantity of resources exceeding the requested quantity of resources, exemplary means for allocating, by the processor, a quantity of available resources of the global pool to the requesting local pool, wherein the allocated quantity of available resources matches the requested quantity of resources, whereby the local pool is enabled to use the allocated quantity of available resources.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for managing distribution of resources between a global pool and an associated plurality of local pools, the method comprising:
receiving, by a processor of a resource manager of a global pool, a request from a requesting local pool of a plurality of local pools, wherein the request indicates a requested quantity of resources from the global pool;
based on receiving the request, determining, by the processor, that a flush threshold of the global pool exceeds an available quantity of resources in the global pool;
based on the flush threshold exceeding the available quantity of resources, sending, by the processor, flush instructions to the plurality of local pools, wherein the flush instructions instruct each local pool receiving the flush instructions to release unused resources to the global pool;
updating, by the processor, the available quantity of resources of the global pool based on resources released by local pools in response to the flush instructions; and
based on the updated available quantity of resources exceeding the requested quantity of resources, allocating, by the processor, a quantity of available resources of the global pool to the requesting local pool, wherein the allocated quantity of available resources matches the requested quantity of resources, whereby the local pool is enabled to use the allocated quantity of available resources.

2. The method of claim 1, further comprising:
sending, by the processor, flush instructions to the plurality of local pools periodically based on a defined schedule.

3. The method of claim 1, wherein the flush instructions instruct each local pool to release unused resources asynchronously; and
wherein the resource manager is configured to process resource requests while sent flush instructions are processed at the plurality of local pools.

4. The method of claim 1, further comprising:
based on the requested quantity of resources exceeding the available quantity of resources, adding, by the processor, the received request to a wait queue of requests, wherein the resource manager allocates available resources to local pools associated with requests in the wait queue of requests based on an order of requests in the wait queue of requests.

5. The method of claim 1, wherein sending flush instructions to the plurality of local pools further includes:
identifying, by the processor, a subset of local pools of the plurality of local pools based on allocated resource quantities of the identified subset of local pools exceeding an allocated resource threshold; and
sending, by the processor, the flush instructions to the identified subset of local pools.

6. The method of claim 1, further comprising:
collecting, by the processor, wait time data of resource requests associated with the global pool and the plurality of local pools;
training, by the processor, a threshold determination engine based on the collected wait time data using machine learning; and
based on the trained threshold determination engine, adjusting, by the processor, the flush threshold to reduce wait times of resource requests.

7. The method of claim 1, wherein, based on receiving flush instructions, the plurality of local pools process the flush instructions, the processing including:
identifying allocated resources associated with accumulated system metadata updates;
writing the accumulated system metadata updates of the identified allocated resources to a disk; and
releasing the identified allocated resources to the global pool.

8. A computer system for managing distribution of resources between a global pool and an associated plurality of local pools, the computer system comprising:
a processor; and
a non-transitory computer readable medium having stored thereon program code for transferring data to another computer system, the program code causing the processor to:
receive a request from a requesting local pool of a plurality of local pools, wherein the request indicates a requested quantity of resources from a global pool;
based on receiving the request, determine that a flush threshold of the global pool exceeds an available quantity of resources in the global pool;
based on the flush threshold exceeding the available quantity of resources, send flush instructions to the plurality of local pools, wherein the flush instructions instruct each local pool receiving the flush instructions to release unused resources to the global pool;
update the available quantity of resources of the global pool based on resources released by local pools in response to the flush instructions; and
based on the updated available quantity of resources exceeding the requested quantity of resources, allocate a quantity of available resources of the global pool to the requesting local pool, wherein the allocated quantity of available resources matches the requested quantity of resources, whereby the local pool is enabled to use the allocated quantity of available resources.

9. The computer system of claim 8, wherein the program code further causes the processor to:
send flush instructions to the plurality of local pools periodically based on a defined schedule.

10. The computer system of claim 8, wherein the flush instructions instruct each local pool to release unused resources asynchronously; and
wherein a resource manager associated with the global pool is configured to process resource requests while sent flush instructions are processed at the plurality of local pools.

11. The computer system of claim 8, wherein the program code further causes the processor to:
based on the requested quantity of resources exceeding the available quantity of resources, add the received request to a wait queue of requests, wherein a resource manager associated with the global pool allocates available resources to local pools associated with requests in the wait queue of requests based on an order of requests in the wait queue of requests.

12. The computer system of claim 8, wherein sending flush instructions to the plurality of local pools further includes:
identifying a subset of local pools of the plurality of local pools based on allocated resource quantities of the identified subset of local pools exceeding an allocated resource threshold; and
sending the flush instructions to the identified subset of local pools.

13. The computer system of claim 8, wherein the program code further causes the processor to:
collect wait time data of resource requests associated with the global pool and the plurality of local pools;
train a threshold determination engine based on the collected wait time data using machine learning; and
based on the trained threshold determination engine, adjust the flush threshold to reduce wait times of resource requests.

14. The computer system of claim 8, wherein, based on receiving flush instructions, the plurality of local pools process the flush instructions, the processing including:
identifying allocated resources associated with accumulated system metadata updates;
writing the accumulated system metadata updates of the identified allocated resources to a disk; and
releasing the identified allocated resources to the global pool.

15. A non-transitory computer storage medium having stored thereon program code executable by a first computer system at a first site, the program code embodying a method comprising:
receiving a request from a requesting local pool of a plurality of local pools, wherein the request indicates a requested quantity of resources from a global pool;
based on receiving the request, determining that a flush threshold of the global pool exceeds an available quantity of resources in the global pool;
based on the flush threshold exceeding the available quantity of resources, sending flush instructions to the plurality of local pools, wherein the flush instructions instruct each local pool receiving the flush instructions to release unused resources to the global pool;
updating the available quantity of resources of the global pool based on resources released by local pools in response to the flush instructions; and
based on the updated available quantity of resources exceeding the requested quantity of resources, allocating a quantity of available resources of the global pool to the requesting local pool, wherein the allocated quantity of available resources matches the requested quantity of resources, whereby the local pool is enabled to use the allocated quantity of available resources.

16. The non-transitory computer storage medium of claim 15, wherein the method embodied by the program code further comprises:
sending flush instructions to the plurality of local pools periodically based on a defined schedule.

17. The non-transitory computer storage medium of claim 15, wherein the flush instructions instruct each local pool to release unused resources asynchronously; and
wherein a resource manager associated with the global pool is configured to process resource requests while sent flush instructions are processed at the plurality of local pools.

18. The non-transitory computer storage medium of claim 15, wherein the method embodied by the program code further comprises:
based on the requested quantity of resources exceeding the available quantity of resources, adding the received request to a wait queue of requests, wherein a resource manager associated with the global pool allocates available resources to local pools associated with requests in the wait queue of requests based on an order of requests in the wait queue of requests.

19. The non-transitory computer storage medium of claim 15, wherein sending flush instructions to the plurality of local pools further includes:
identifying a subset of local pools of the plurality of local pools based on allocated resource quantities of the identified subset of local pools exceeding an allocated resource threshold; and
sending the flush instructions to the identified subset of local pools.

20. The non-transitory computer storage medium of claim 15, wherein the method embodied by the program code further comprises:
collecting wait time data of resource requests associated with the global pool and the plurality of local pools;
training a threshold determination engine based on the collected wait time data using machine learning; and
based on the trained threshold determination engine, adjusting the flush threshold to reduce wait times of resource requests.
